(19) United States
(12) Patent Application Publication
(10) Pub. No.: US 2026/0010931 A1
(43) Pub. Date: Jan. 8, 2026

(54) System and Method for Improved Ratings

(71) Applicant: PikiCo, Inc, Wimauma, FL (US)

(72) Inventors: Tim Conley, Wimauma, FL (US); Kaitland Taflinger, Ruskin, FL (US); Tina Marie Conley, Wimauma, FL (US)

(73) Assignee: PikiCo, Inc, Wimauma, FL (US)

(21) Appl. No.: 18/763,687

(22) Filed: Jul. 3, 2024

(51) Int. Cl. G06Q 30/0282

(52) U.S. Cl. CPC G06Q 30/0282

(57) ABSTRACT

A system and method for rating products and/or services requests ratings in several categories and provides a cumulative rating for each category. Sorting tools rank the products and/or services based upon a user-selected priority of one or several of the categories or criterion. For example, list Italian restaurants within 10 miles sorted by price and food quality; or list Italian restaurants within 10 miles sorted by ambiance . . . . In some embodiments, a reviewer is able to provide a zero-star rating, but only after confirming an escalation such as speaking with the staff/manager/owner regarding the issue and not receiving a satisfactory resolution. Granular ratings provide managers and owners detailed data specific to fine-tune items such as individual items (e.g., menu items), service, price, ambiance, etc., providing data for decision making (e.g., fixing a poorly rated menu item). A rating algorithm considers the age of each individual rating.

### FIELD OF THE INVENTION

This invention relates to providing ratings and reviews for various products, services and/or establishments, for example, ratings and reviews for a restaurant.

### BACKGROUND OF THE INVENTION

Ratings are very useful when trying to decide where and what to eat, where to stay, what vehicle to buy, where to shop for a certain item, which product/brand to buy, etc. Today, countless retailers and non-related websites rate and rank everything from restaurants to hotels, clothing to cars—you name it and it's highly likely someone has reviewed it and rated it.

Today, the number of reviews/ratings are important. After all, if only one person has rated a specific establishment or product as good, that is only one person's opinion, but if one hundred people rated that establishment as good, then this carries more weight, but what if half of those reviews were from months or years ago? How important or relevant are those reviews today? Maybe the product has been improved, or the establishment has new ownership or staff, or a restaurant has changed its menu?

People are generally very good at providing their opinions. Often, people are asked for a review after they buy the goods or use the services. For example, a receipt might have a link to a web site, or a phone number, where they can provide a review of the establishment, products, and/or services. Sometimes, they may even be incentivized to provide their review, such as a getting a free, or discounted, item once they provide their review. They may also independently use well-known third-party websites to provide their opinion, such as Google, Yelp, and TripAdvisor, to name a few. This is generally accepted as valuable, but although these reviews sometimes have a text box to add detail, a single-star rating is simply an overall rating. You might assume, provided that five stars is the top rating available, a product, service, or establishment that has a four-star rating had something that wasn't good enough to give it a five-star rating. Maybe the reviewers thought the prices were too high, or maybe the dish they had was cold, or maybe the waitstaff was rude. If the reviewer doesn't specify what the specific reason was for not giving a five-star rating in the description/textbox, then there is no way to tell why they rated the product, service, or establishment with only four stars. Or, conversely, if a reviewer provides a one-star rating on a product, service, or establishment and doesn't provide additional detail in the description/textbox, then how does that provide value to the public and/or provider of the products or services? Furthermore, with today's review systems, older reviews are being combined in the overall rating for the product, service, or establishment. The older reviews are simply aggregated and averaged with the newer reviews from the beginning of time. But what if someone gave a restaurant a one-star rating five years ago because the waiter was rude, but that waiter no longer works at the restaurant? Or someone gave a five-star review of the restaurant five years ago, but now it's in disrepair or under different ownership/management. How relevant are those reviews today?

With today's review systems, one can search for something, for example a restaurant, and they will be presented with a list of restaurants with the option to filter and sort by some criteria such as ratings, location, cuisine, etc. Currently, the review system will show you the overall rating for each restaurant, but does an overall rating provide real value? Or should the rating even be static? What if there are multiple factors to be considered in the rating that could change the star-value from one day to the next, or from one person to the next? For example, one day you're looking for a restaurant that has good takeout food because you just want to pick something up for dinner on the way home and you find a five-star rated restaurant in a strip mall, but the next day, you're looking for a place with great ambiance and customer service because you want to take your partner out on a date for your anniversary. In the first example, the food quality is more important than ambiance because you're not eating in, but on the second example, ambiance and customer service is more important than food quality because you're out on a date. If the two scenarios above happened to be two different people searching for a place to eat on the same day, then the five-star restaurant in the first example with the great food wouldn't be five stars for the one on the date because they each had different priorities that were important to them at that time. With today's review data and tools, the rating is an overall rating. Also, it's an average rating that is without regard to age and relevance of the rating. It would be nice if the ratings could be dynamic and take into account the age of the rating, as well as, what is more important to you on a given day and allow you to search for restaurants based on food quality on one day, but then the next day you could search for restaurants that have better ambiance, customer service, etc. Thereby the star rating should be different from one person to the next, or for the same person from one day to the next, based on individual priorities and preferences at a point in time.

What is needed is a system and method that provides useful ratings and reviews that provides detail feedback to the companies that provide the goods and/or services, as well as, the consumers who are using the ratings and reviews to help them make better decisions.

### SUMMARY OF THE INVENTION

A system/method that provides a more granular/detailed rating and reviewing of various products, services and/or establishments using multiple categories that provide a cumulative rating for each category and a collective effect across all categories while taking into account the age and importance of the ratings/reviews. The system/method provides sorting and filtering tools to search for the products, services and/or establishments using on-demand preferences and choices of importance and priority at time of use. For example, let's say you're in the mood for lasagna, but you want to pick it up and take it home to eat. In this case, your priorities are; 1) best lasagna, 2) not too far away, for the 3) best price with 4) quick service. The system/method will allow you to search for and provide a list of restaurants within 10 miles that have the highest-rated lasagna, sorted by location, price, and speed of service. Another example is you and your partner dress up and are going on a date. You would like lasagna, but your partner would like shrimp. In this case, you want to find a restaurant that has good lasagna as well as good shrimp, but better ambiance and customer service and, since you're on a date, those are more important to you than the price or speed of service. So, your priorities would be; 1) best ambiance and 2) best customer service with 3) good lasagna and 4) good shrimp, sorted by 5) location. Of course, the ratings/reviews in these examples will be weighted by the age of the rating/review. With the ability to have granular and relevant review and ratings data, the system/method provides managers, owners, and service providers information that is detailed and specific to items and consumer experiences that will help them fine tune their business offerings. Including, but not limited to, rating Individual Items (e.g., menu items, products, etc.), Customer Service (e.g., employee level ratings, conflict resolution, etc.), Establishment (e.g., ambiance, atmosphere, décor, etc.), Price (e.g., local market comparisons, market value, etc.), Location (e.g., distance customer traveled, local area comparisons, etc.). Thereby providing data for better decision making (e.g., changing a poorly rated menu item, updating the décor, etc.). In some embodiments, the combined ratings for each category are calculated and weighted by an algorithm that takes into account the age of each individual rating. For example, a rating of the customer service from two years ago might carry a portion of the weight as a rating of the customer service from last week as wait staff come and go. It is also expected that the algorithm can be tuned for each category. For example, when customer service in a restaurant is concerned, little weight is given for ratings that are three years old, but when ambiance is concerned, a more linear weight is applied as the overall establishment décor does not change as often. As an alternative to the current ratings systems, in some embodiments, a reviewer is able to provide a zero-star rating. However, this will require extra effort and steps. Such as, allow a zero-star rating only after confirming that the reviewer spoke with the management/owner regarding the issue and attempted to give them a chance to remedy the situation and only after there was no satisfactory resolution.

In one embodiment, a method for rating products or services includes creating an account for a user, then, after receiving a product or a service from an establishment, the user providing a description of the product or the service and ratings for categories related to the product or the service. The name of the establishment, the description of the product or the service, the date of receiving the product or the service is then stored in the ratings in a database.

In another embodiment, a method for rating restaurants includes creating an account for a user, then after receiving a meal from a restaurant, the user providing a description of the meal and ratings for categories related to the meal using the account. The name of the restaurant, the location of the restaurant, the description of the meal, the date of receiving the meal, and the ratings are stored in a database.

In another embodiment, a system for rating products and services includes a user device having a processor, an input device interfaced to the processor, a network interface interfaced to the processor and communicatively coupled to a network, a display interfaced to the processor, and a memory interfaced to the processor. There is also a server computer having a server processor, a server memory interfaced to the server processor, a server network interface operatively interfaced to the processor and communicatively coupled to the network, and a persistent storage operatively coupled to the server computer and accessible by the server processor. A ratings database is stored in the persistent storage. The processor is configured to receive rating data from the input device and to send the rating data to the server computer and the server processor configured to store the rating data in the ratings database along with a timestamp. The rating data includes a name of an establishment, a name of the product or the service and at least two categories of the rating data selected from a group consisting of quality, service, price, and ambiance.

### BRIEF DESCRIPTION OF DRAWINGS

The invention can be best understood by those having ordinary skill in the art by reference to the following detailed description when considered in conjunction with the accompanying drawings in which:

FIG. 1 illustrates a data connection diagram of the system and method for rating products and/or services.

FIG. 2 illustrates a schematic view of a typical smartphone.

FIG. 3 illustrates a schematic view of a typical computer system such as a server or personal computer.

FIGS. 4-13 illustrate exemplary smartphone user interfaces of the system and method for rating products and/or services.

FIGS. 14-17 illustrate administrative or back-end user interfaces of the system and method for rating products and/or services.

FIGS. 18-20 illustrate operation of the rating system.

FIGS. 21-23 illustrate exemplary program flows of the rating system.

FIGS. 24-26 illustrate a sample rating input form or user interface of the rating system.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Although the described rating system is anticipated to be used to rate anything such as hotels, rental services, restaurants, vacation destinations, products, medications, drinks, wine, realtors, etc., throughout this description, an example of rating a restaurant is used for clarity and brevity reasons. The term manager will be used to refer to anyone in charge of the restaurant, which includes the owner, proprietor, or a specific person that is delegated the responsibility. The term “reviewer” refers to anyone who provides ratings or reviews, in this example, ratings/reviews of the restaurant. The term “categories,” refers to the individual criteria on which the product/service is rated, in this example, an exemplary set of categories includes the food, the service, the price, the location, and the ambiance. The categories are not locked in stone and others are anticipated (e.g., amount of food, speed of service, background noise levels, lighting levels, décor, etc.). For other products/services, different categories are anticipated. For example, hotel ratings have room cleanliness, staff courtesy, location, frequency of airport shuttle, lobby quality, bed quality, television quality, amenities, etc.

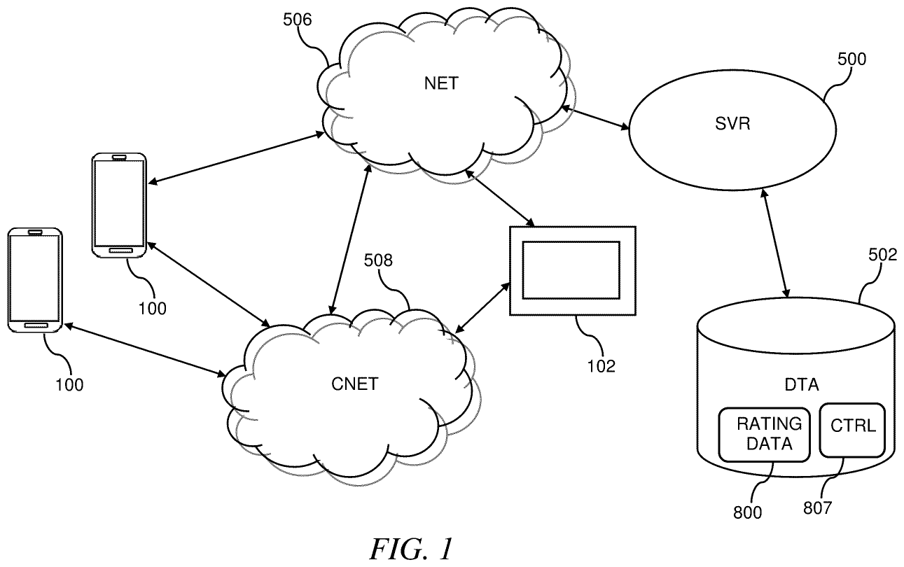

Referring to FIG. 1 illustrates an exemplary data connection diagram of the rating system. In this example, one or more devices such as smartphones 100 and/or personal computer 102 communicate through the cellular network 508 and/or through a data network 506 (e.g. the Internet) to a server computer 500.

The server computer 500 has access to data storage 502 (e.g. “cloud” storage or local storage) that is used to store rating data 800 and control files 807. As will be shown, the rating data 800 includes rating provided from individual reviews of products and services, each time stamped as to the date of purchase and/or use of the product or service. The control files 807 provide guidance to software that processes and presents the rating data, for example, controlling the weighting of rating data based upon age of the data (e.g., ratings for service are weighted at 75% after one year and 45% after 2 years).

It is fully anticipated that the user interfaces, prompts, data, information, etc., be stored/received, displayed, and/or output in any language known.

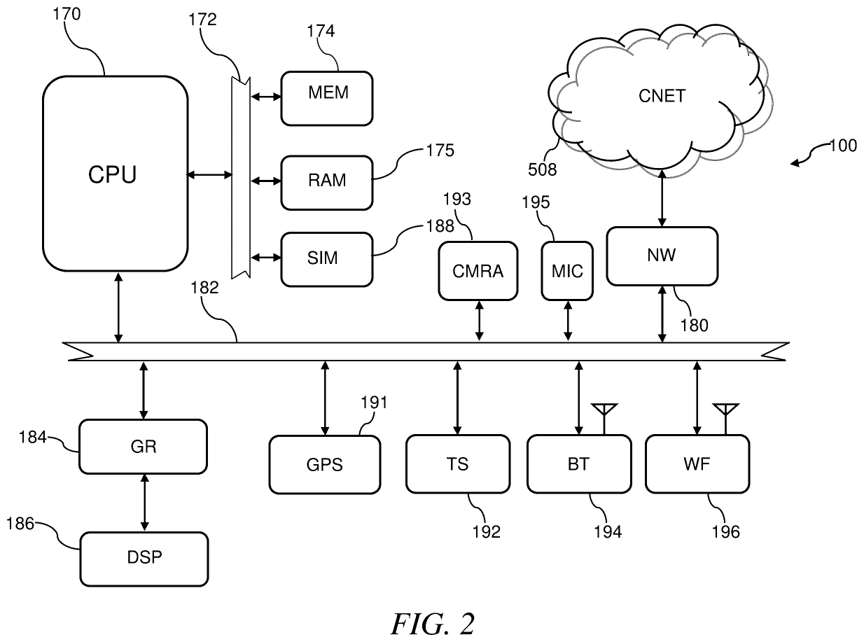

One path between the smartphones 100, personal computers 102, and the server computer 500 is shown going through the cellular network 508 and the data network 506, any known data path is anticipated. For example, the Wi-Fi transceiver 196 (see FIG. 2) of the smartphone 100 is used to communicate directly with the data network 506, which includes the Internet, and, consequently, with the server computer 500.

The server computer 500 transacts with software running on the smartphones 100 through the network(s) 508/506. The software (e.g., an application) presents menus to/on the smartphones 100, provides data to the smartphones 100 and personal computer 102, and communicates information to/from the server such as images, video, and voice.

The server computer 500 transacts with an application running on the smartphone 100 and/or personal computer 102 as needed, for example, when receiving a review from the reviewer. Although in this disclosure, a smartphone 100 and/or personal computer 102 is used as an example, any processor-based device is anticipated including, but not limited to, a personal computer, a tablet computer, and a smart watch.

The rating system stores rating information in the rating data 800 (e.g. in data storage 502 that is local to the server computer 500, cloud-based storage, etc.).

Referring to FIG. 2, a schematic view of a typical end-user device, a smartphone 100 is shown. Although any end-user device is anticipated such as smart watches, tablets, personal computer 102, for clarity purposes, a smartphone 100 will be used in the remainder of the description for brevity and clarity reasons.

The rating system is described using a processor-based end-user device (e.g., smartphone 100) for providing the login and interaction with user interfaces necessary for gathering and using ratings. The present invention is in no way limited to using a smartphone 100 and any similar device is anticipated (e.g., cellular phone, portable digital assistant, tablet, notebook, smart watch, etc.).

The example smartphone 100 represents a typical device used for accessing user interfaces of the system for managing construction. This exemplary smartphone 100 is shown in its simplest form. Different architectures are known that accomplish similar results in a similar fashion and the present invention is not limited in any way to any particular smartphone 100 system architecture or implementation. In this exemplary smartphone 100, a processor 170 executes or runs programs in a random-access memory 75. The programs are generally stored within a persistent memory 174 and loaded into the random-access memory 175 when needed. Also accessible by the processor 170 is a SIM card 188 (subscriber information module) having a subscriber identification and often persistent storage. The processor 170 is any processor, typically a processor designed for phones. The persistent memory 174, random-access memory 175, and SIM card are connected to the processor by, for example, a memory bus 172. The random-access memory 175 is any memory suitable for connection and operation with the selected processor 170, such as SRAM, DRAM, SDRAM, RDRAM, DDR, DDR-2, etc. The persistent memory 174 is any type, configuration, capacity of memory suitable for persistently storing data, for example, flash memory, read only memory, battery-backed memory, etc. In some exemplary smartphones 100, the persistent memory 174 is removable, in the form of a memory card of appropriate format such as SD (secure digital) cards, micro-SD cards, compact flash, etc.

Also connected to the processor 170 is a system bus 182 for connecting to peripheral subsystems such as a cellular network interface 180, a graphics adapter 184 and a touch screen interface 192. The graphics adapter 184 receives commands from the processor 170 and controls what is depicted on the display 186. The touch screen interface 192 provides navigation and selection features.

In general, some portion of the persistent memory 174 and/or the SIM card 188 is used to store programs, executable code, and data, etc. In some embodiments, other data is stored in the persistent memory 174 such as audio files, video files, text messages, etc.

The peripherals are examples and other devices are known in the industry such as Global Positioning Subsystem 191, speakers, microphones, USB interfaces, camera 193, microphone 195, Bluetooth transceiver 194, Wi-Fi transceiver 196, image sensors, temperature sensors, etc., the details of which are not shown for brevity and clarity reasons.

The cellular network interface 180 connects the smartphone 100 to the cellular network 508 through any cellular band and cellular protocol such as GSM, TDMA, LTE, 5G, etc., through a wireless medium. There is no limitation on the type of cellular connection used. The cellular network interface 180 provides voice call, data, and messaging services to the smartphone 100 through the cellular network 508.

For local communications, many smartphones 100 include a Bluetooth transceiver 194, a Wi-Fi transceiver 196, near-field transceivers, or any combination of such. Such features of smartphones 100 provide data communications between the smartphones 100 and data access points and/or other computers such as a personal computer 102.

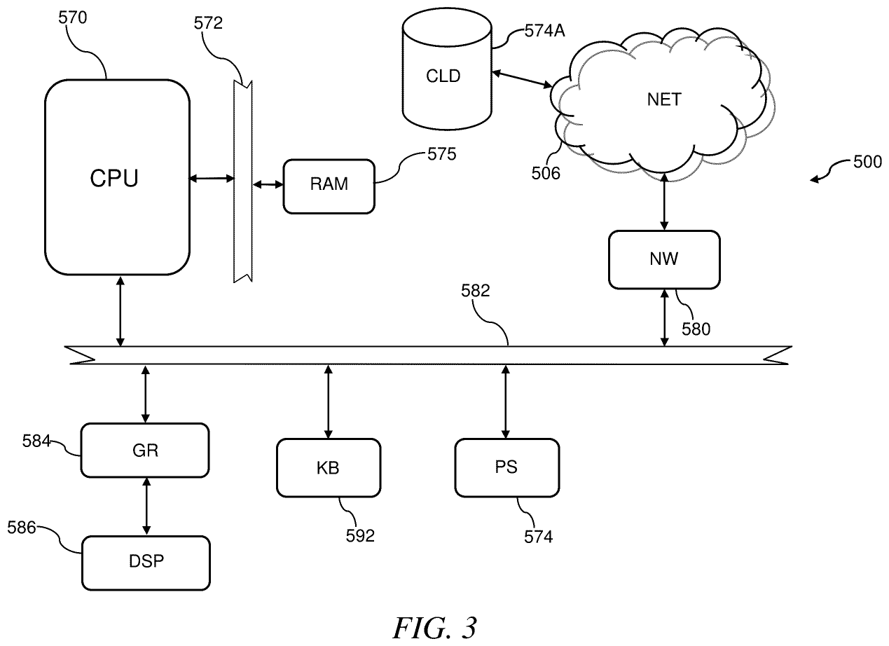

Referring to FIG. 3, a schematic view of a typical computer system (e.g., server computer 500) is shown. The example computer system (server computer 500) represents a typical computer system used for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 (e.g., disk storage) is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus-USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, data, a rating data 800, and other data, etc. In some embodiments, persistent memory is provided through cloud storage 574A connected through the data network 506.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

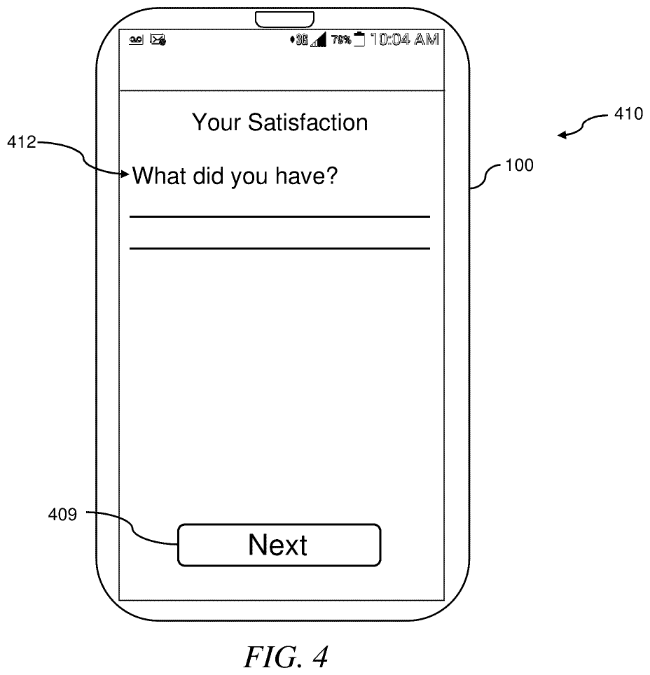

Referring to FIGS. 4-13, exemplary user interfaces of the rating system are shown operating in the learning mode, learning information about the person. For brevity and clarity reasons, the login process for reviewers and managers is not shown as there are many login processes anticipated, requiring usernames, passwords, biological samples (e.g., fingerprints), secondary authentication, knowledge of pre-entered facts (e.g., first school name), etc. In general, it is assumed that the reviewer or manager is already logged in throughout the remainder of this description. Also, for brevity and clarity reasons, the rating system is described with respect to visiting a restaurant or other eating establishment and similar or different user interfaces are presented for various types of products or services, some have only a single review requested per item (e.g., purchase of a new car battery).

Note that to provide incentive to the reviewer to enter review information, various rewards or points systems are anticipated as known in the industry. For example, the user is awarded points for each review entered that are retrievable for gifts, discounts, or chances to win prizes.

Referring to FIG. 4, in some embodiments, after logging in, a data entry user interface 410, the reviewer is asked to describe the food and/or drinks they had. The reviewer is prompted with a general message 412, “What did you have?”, in which the reviewer will enter the food and drink that they had (e.g., “fried shrimp and iced tea”), many other user interfaces are anticipated including receiving information from the establishment's ordering system with details of what the reviewer orders (e.g., “ribeye steak medium well, mashed potatoes, green beans, sweet iced tea, etc.”). This information is retained for access by the manager of the establishment, and/or other third-parties who may benefit from knowing the data, (e.g., to understand what products/services the reviewer had when reviewing the user ratings and reviews) as well as to the reviewer, so the reviewer can determine what they had and/or liked in prior visits to the establishment . . . . In some embodiments, the reviewer is able to upload an image and/or video.

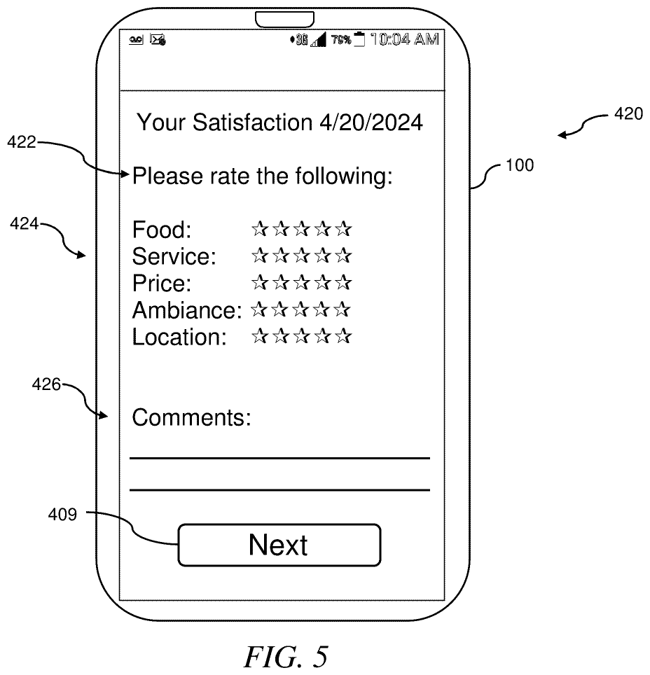

Referring to FIG. 5, a primary rating user interface 420 is shown. In this, the reviewer has instructions 422 (e.g., “please rate the following”) and review entries 424, one for the reviewer to rate each review category that is to be captured (e.g. how was the food, the service . . . ). In some embodiments, there is a comment area 426 in which the reviewer is able to enter specific comments like, “the shrimp were too salty.” When complete, the reviewer selects the next directive 409.

Note that some users have anxiety with certain ways of selecting a rating. For example, certain people believe that the number 4 is unlucky as one word for the number 4 in their language is the same as death. Therefore, for those, picking a number from a set of numbers that includes ‘4’ may be difficult. To reduce such anxiety, it is anticipated that during registration or changing of settings, the user has the ability to select a scheme for entering the ratings. For example, one scheme is numbers 1-5, one scheme is selecting a number of stars, such as one to five stars, one scheme is to select an icon that indicates very happy, happy, okay, sad, very sad, etc. (e.g., [symbol] ).

In some embodiments, rating data is collected for others in the party, especially when those others are minors such as children and want to provide a review of the food and service received.

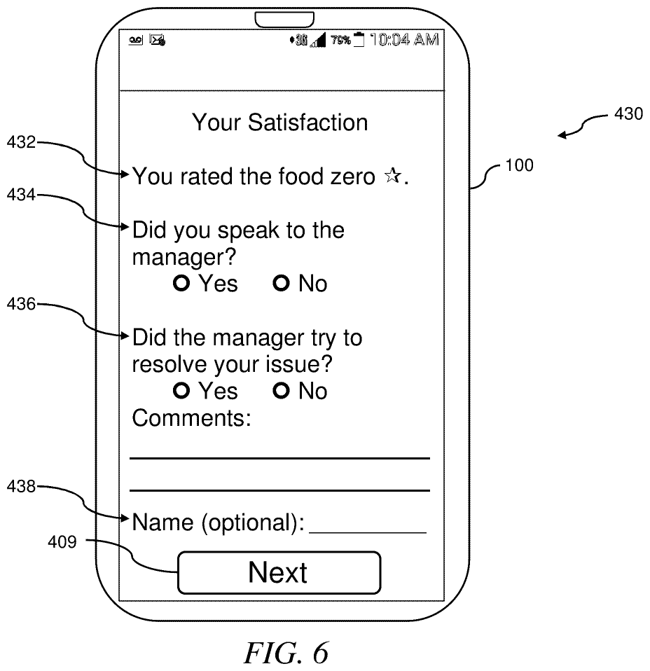

Referring to FIG. 6, a zero-rating user interface 430 is shown. If the reviewer did not provide any stars for an item, the rating system requires that the reviewer “go the extra mile” in order to maintain this zero rating. In other words, the reviewer is discouraged from simply giving a zero rating without first trying to resolve the issue with the establishment, preferably the wait staff and/or manager/owner. In the zero-rating user interface 430, an indication 432 is provided as to what item the reviewer gave a zero rating, in this example, the food. The reviewer is required to respond to some questions. For this instance, the first question 434 asking if the reviewer escalated the problem to the waitstaff or manager, and the second question 436 asking if the waitstaff or manager tried to resolve the issue. In some embodiments, a field is provided for the reviewer to add comments and, if the reviewer wishes, the reviewer has a name field 438 to leave their name. In some embodiments, the name is required to reduce abuse of the zero rating. In this way, say that the reviewer's shrimp were too salty to eat. If they didn't escalate the issue, after pressing next 409, the zero-star rating is not accepted, either reverting back to the primary rating user interface 420 where the reviewer is able to add a star, or a star is automatically added for the reviewer. Now, if the reviewer did discuss the issue with the waitstaff and/or manager and the waitstaff/manager did not offer a satisfactory resolution (e.g., the manager told the reviewer that they ate 3 of the six shrimp and, therefore, could not send it back), then the reviewer indicates that the issue wasn't resolved and the zero-star rating is made. Note that if the manager tried to resolve the issue, the rating system will either keep the zero-star rating, as it is assumed that the manager did not offer anything that truly resolved the issue, or the zero-star rating is removed as above. In either case, the establishment will be able to provide their side of the story in the rating system, so the zero-star rating cannot be abused. (e.g., debate the fact they were contacted and given a chance to remedy the situation and/or offered a resolution). Thereby, applying a weight to the zero-star review that is not equal to the weight of other related reviews. In some embodiments, more or less action is required by the reviewer to give a zero-star rating. For example, in some scenarios, the transaction includes taking home food (take-out) and the user has reached their home when they realize there is a problem with the order. In such, there may only be an escalation by phone call without any satisfaction from whoever answers the call, maybe not the manager.

In some embodiments, there is an ability to keep a review private, not sharing any part of the review with others. In such, the user is able to see all the details of the private review and the ratings still calculate into the overall ratings, but others are not able to see the review and are not able to correlate the review to the user (reviewer).

Assuming several reviews have been made by several reviewers, having this data, the following exemplary user interfaces are provided for finding establishments, services, products, etc.

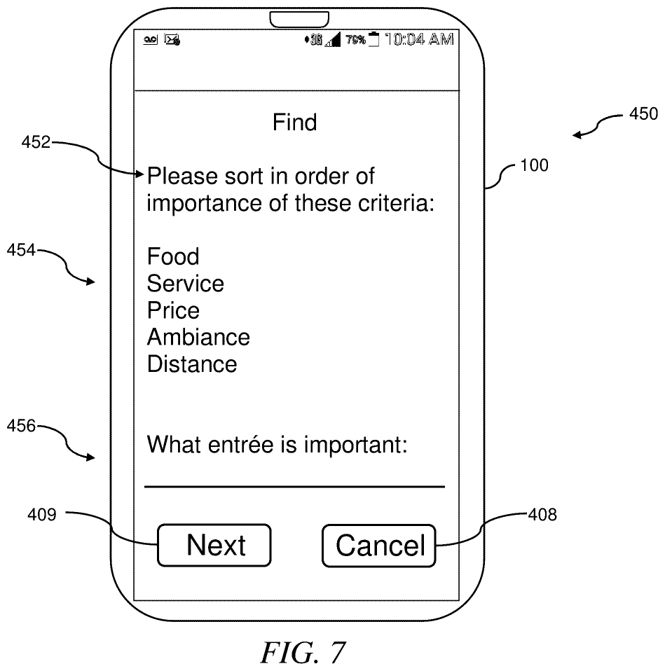

Referring to FIG. 7, a “find” user interface 450 is shown. In the “find” user interface 450, there are criteria 454 for the searcher to rank so as to find establishments, services, products, etc., that meet the searcher's needs. The instructions 452 inform the user to rank the criteria 454 in order of importance, for example, by dragging the most important criteria 454 to the top, assigning a numeric value to each criteria 454, etc. In some embodiments, there is a free-form field 456, in this example, a free-form field 456 for entering what entree or category of food is important. For example, if the searcher is looking for good food at a good price and interested in seafood, Price is moved to the second position and “seafood” typed into the free-form field 456. This would find establishments that provide good sea food at good prices first. Now, if the searcher is looking for ambiance and not worried about price or type of food, then ambiance is moved to the top of the criteria 454, the free-form field is left blank and the searcher will find establishments that have nice ambiance listed first in the results.

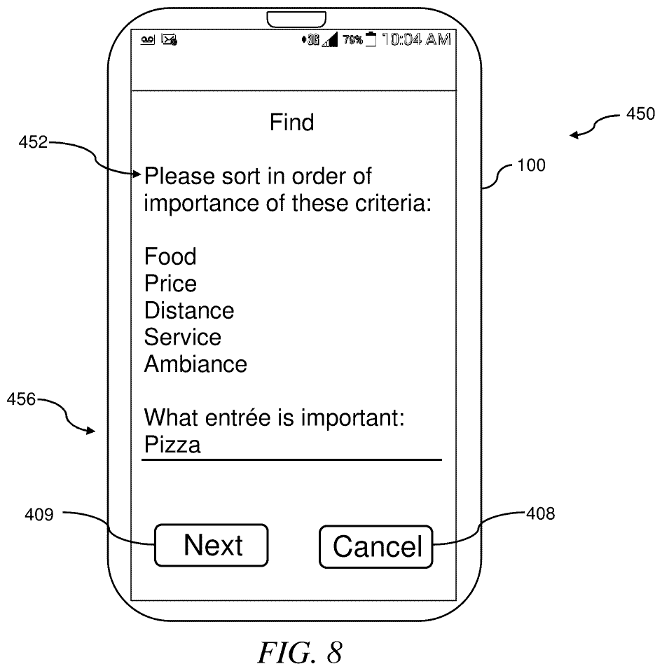

Referring to FIG. 8, the “find” user interface 450 is shown ready for searching, the searcher has moved ambiance to the bottom of the criteria 454 (e.g., they are picking up the food to go) and indicated that they are looking for “Pizza.” After the searcher selects next 409, the results are shown.

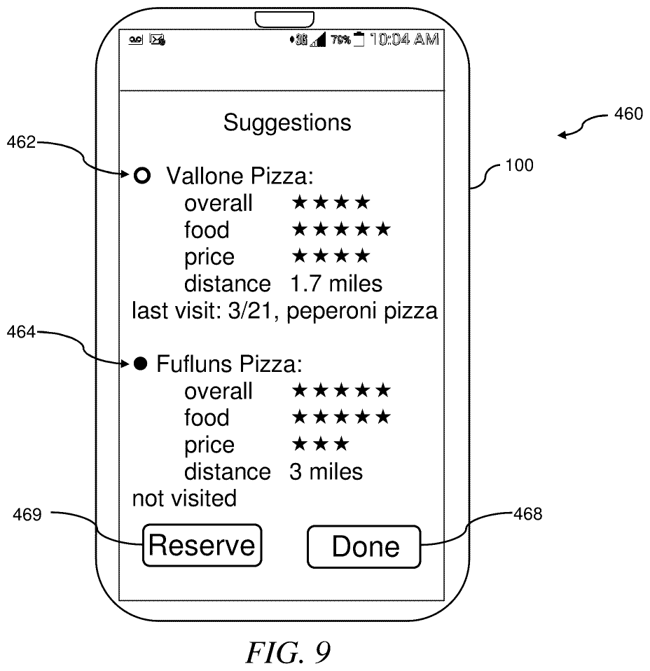

Referring to FIG. 9, a results user interface 460 is shown. The results user interface 460 shows a list of one or more establishments, services, products, etc., produced from the search criteria. In this example, the user is looking for pizza with food being the highest criteria. Two pizza restaurants 462/464 were found, both having five-star food rating. As the searcher's second criteria was price, the establishment with better price rating (4-star) is on top. In this example, the searcher has selected the second pizza restaurant 464. The searcher is able to select done 468 (or back, etc.) or reserve 469 to make a reservation at the second pizza restaurant 464.

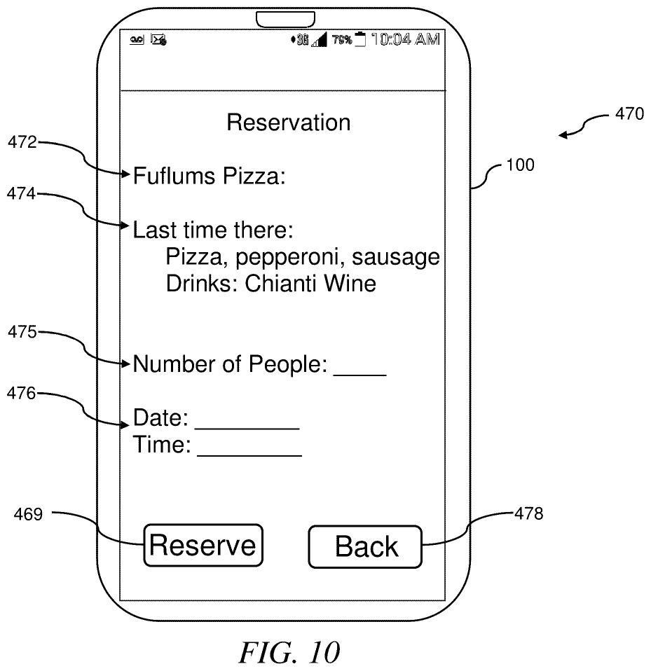

Referring to FIG. 10, a reservation user interface 470 is shown. The reservation user interface 470 shows the establishment name 472, etc. If the searcher was at the establishment previously and indicated what they had (or information regarding what the searcher had was captured from the billing system), the menu items 474 are displayed. The searcher has the opportunity to enter a number of people 475 in their party. The searcher enters the date/time 476 for the reservation (or the date/time 476 are automatically filled in), then selects the reserve directive 469 or, the back directive 478, for example, if the searcher wants to go back and select a different establishment . . . .

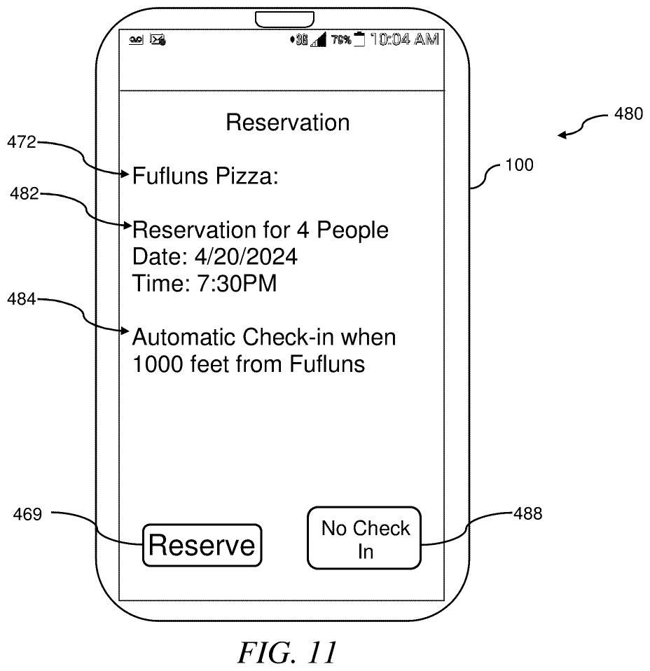

Referring to FIG. 11, a reservation confirmation user interface 480 is shown. The reservation confirmation user interface 480 shows the establishment name 472, the reservation details 482 (e.g., number of people in the party, date and time) and, in some embodiments, when the establishment has “automatic check-in,” details regarding the automatic check-in 484 feature. The searcher has a directive to complete the reservation 469 or to complete the reservation without automatic check-in 488. The latter is desired should the searcher know that they will be closer to the establishment than the automatic check-in distance, but perhaps shopping at a neighboring establishment and does not want to automatically check-in too early . . . .

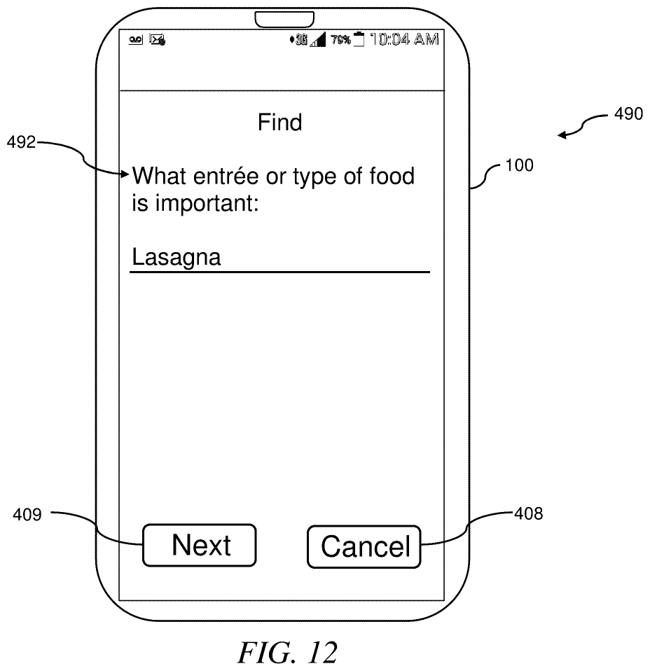

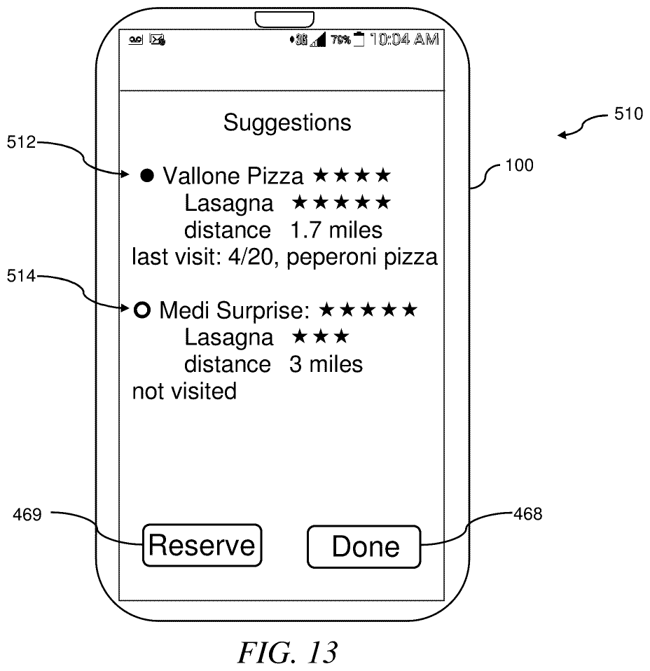

Referring to FIG. 12, another search user interface 490 is shown. In this alternate search user interface 490, the user enters 492 the entree or type of food that they are interested in and then selects the next directive 409 (or cancel 408) to move to the search results user interface 510 as shown in FIG. 13. In the search results user interface 510, the individual rating for the selected food type or entree (in this example, Lasagna) is the predominate criteria and the results show two establishments 512/514, one with 5-star lasagna and one with 3-star lasagna. In this example, search results user interface 510 also shows that the first establishment 512 was visited by the searcher and the date of the visit. As above, the searcher has a reserve directive 469 and a done directive 468 that function as described above.

Over time, the rating system will accumulate a large amount of detailed information from the individual reviews and ratings. Much of this information will be important, not only for searching, but for helping establishments, retailers, suppliers, manufacturers, etc., make product choices, improvements, price adjustments, etc.

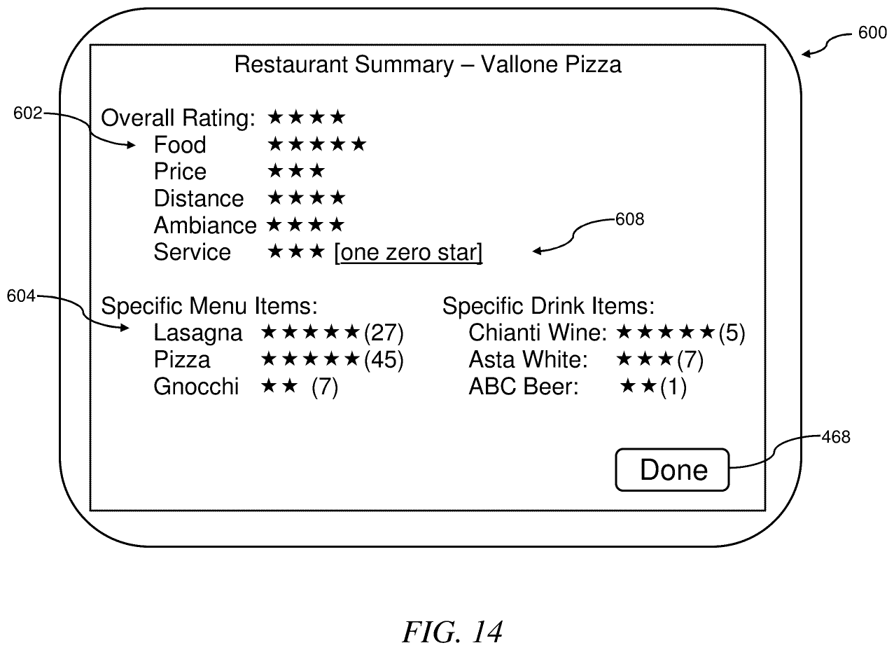

Referring to FIG. 14, an exemplary establishment user interface 600 of the rating system is shown. In this, there is a first section 602 showing the overall ratings and ratings based upon the criteria used to rate the food, price, distance, ambiance, and service. Next, there are granular ratings 604 for whatever granularity of items have been rated. For example, if reviewers indicate they had a certain food item and rated that item, this will contribute to the granular ratings 604 of the food items. In this example, 27 reviewers had the lasagna, and all gave it a 5-star rating. The manager will also see that only 7 reviewers had the gnocchi and the overall rating for the gnocchi was only two-star. Based upon this, the manager may rethink this menu item, either changing the recipe, lowering the price, or removing this entree from the menu.

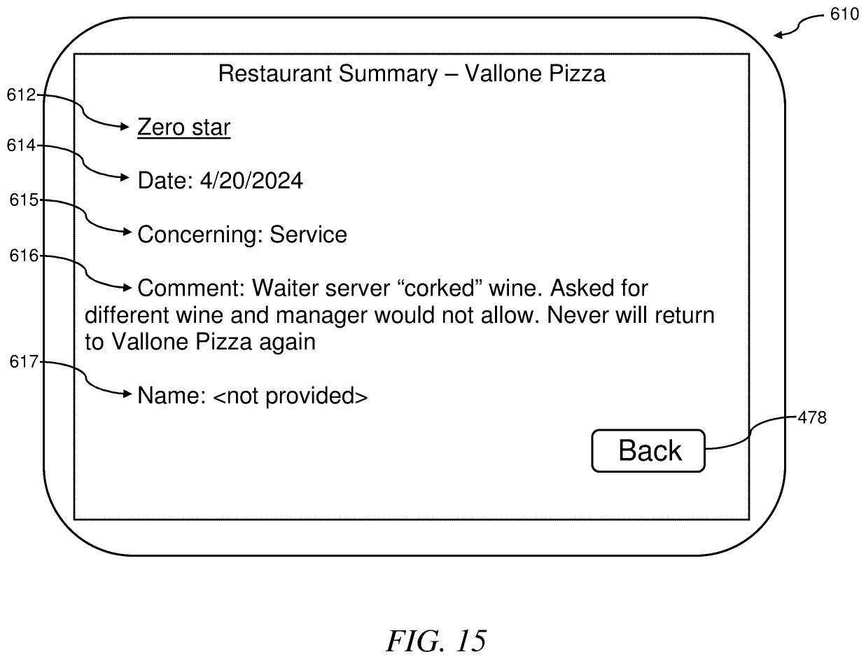

Note that the rating for service had only an overall three stars and received a single zero-star rating 608. By clicking on the zero-star rating 608 (e.g., hyperlink), a secondary restaurant user interface 610 of FIG. 15 is displayed, highlighting the zero-star rating 612 along with the date 614 that the rating was entered, the category 615 (service), the comment 616, and the name of the reviewer 617, if provided.

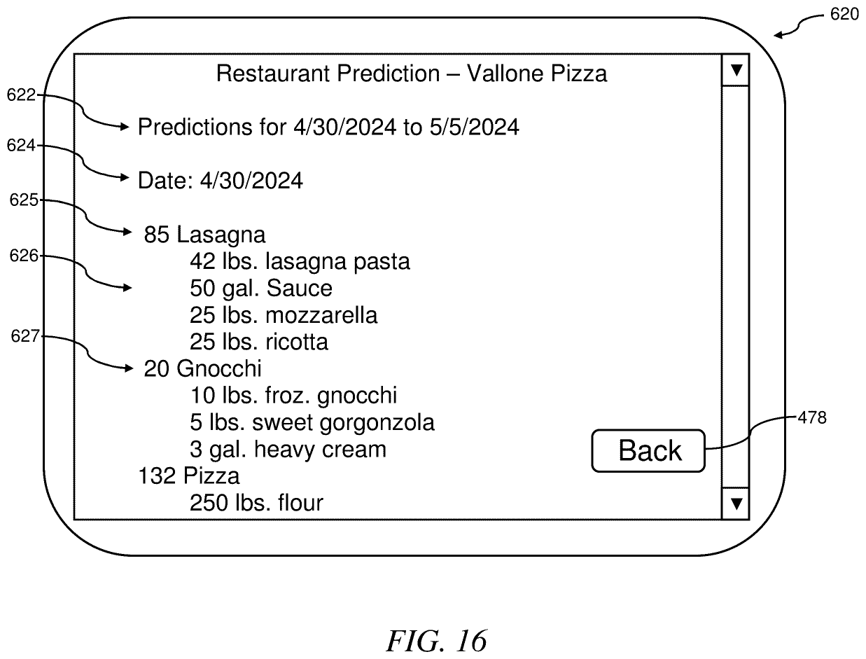

Again, having the amount of granular data provided in the reviews, in some embodiments, the review system will provide intelligence (e.g., using Artificial Intelligence) to make predictions based upon recent data, as shown in FIG. 16. In this example, the review system is making predictions 620 for a future date range 622 on a specific date 624. The predictions include an expected sale of 85 lasagna 625 that will require a specific set of lasagna ingredients 626. The prediction also includes that 20 plates of gnocchi 627 will be sold, along with the ingredients, and 132 pizza along with their ingredients. Note that, after gathering data for several months/years, the prediction algorithms will recognize certain trends. For example, if the establishment is in a mall and the week between Christmas and New Years Day is extremely busy, the algorithms, consulting prior years for the week after New Years Day, will recognize that there was a historically significant drop in business that week and will adjust predictions accordingly. Another example is a restaurant learns specific dishes are ordered more on one day of the week than the others (e.g. more tacos are sold on Tuesdays, so they order more taco ingredients accordingly and promote “Taco Tuesdays” to capitalize on the trend). In some embodiments, predictions are suppressed until sufficient historical data is accumulated.

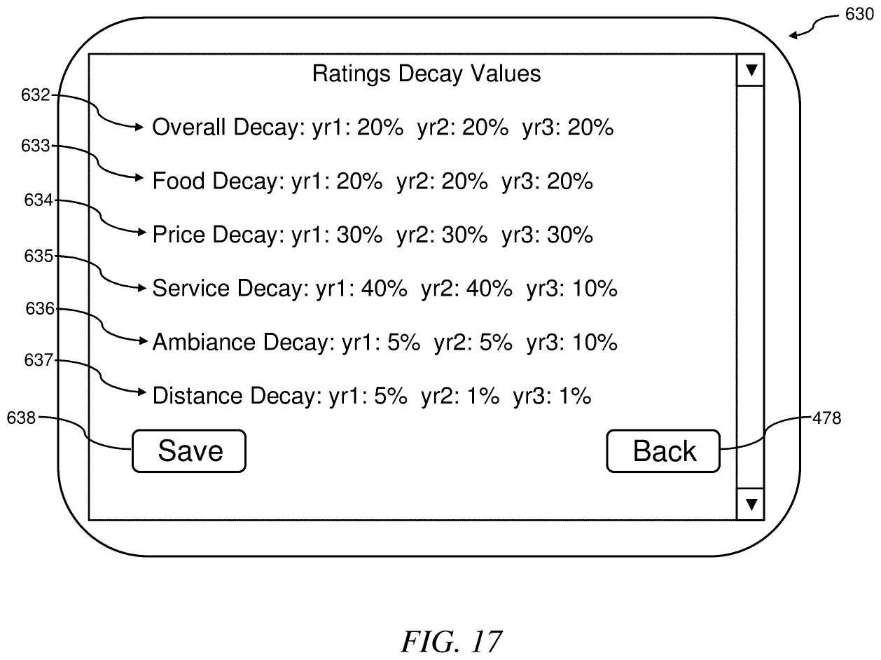

As discussed previously, some rating data gets old fast while other rating data ages very little. Take for example, ratings for ambiance. If an establishment is elegant today, assuming there were no recent makeovers or damages, that establishment was likely just as elegant last year and the year before that and, therefore, ambiance ratings age very little. In contrast, waitstaff turnover is frequent, so a bad rating on customer service from three years ago could be for a completely different waitstaff than exists today. Therefore, the rating system provides for a set of decay values for each granular criteria, for example, as in the decay user interface 630 of FIG. 17. In this exemplary decay user interface 630, the overall rating 632 and each granular criteria 633/634/635/636/637 is shown on a separate line and each has a decay percentage per year (the time of decay is also variable/customizable, i.e. weeks, months, years). For example, based upon the above, the ambiance decay 637 is only 5% in the 1^{st} year, 5% in the 2^{nd} year and 10% in the 3rd year; while the service decay 635 (e.g. waitstaff) is 40% in the first year, 40% in the 2^{nd} year and 10% in the 3rd year. Each decay value is adjustable by entering a new value, then when finished, activating the save directive 638. To go back without saving, the back directive 478 is activated.

Further, it is anticipated that an establishment might change some part of the offering which may nullify some of the reviews. For example, if a furniture supplier has an overall 3-star rating for a specific chair due to reliability and they decide to change suppliers for that chair, the new supplier might have higher or lower reliability. Similarly, a restaurant might recognize that they are receiving low ratings for one menu item, such as the shrimp scampi, with comments saying too much garlic. After reading the reviews, the restaurant then changes the recipe to another that has less garlic. In such, the establishment needs a way to indicate this change so that the old reviews no longer apply. Of course, once the change is made and old reviews retired, that food item will have no reviews until people start ordering that item and reviewing. Still, other reviews for that establishment will prevail. In a similar way, if an establishment changes locations, prior reviews of the old location (e.g., ambiance) likely do not apply to the new location. The present invention provides settings for the establishment to nullify reviews for certain categories after such changes.

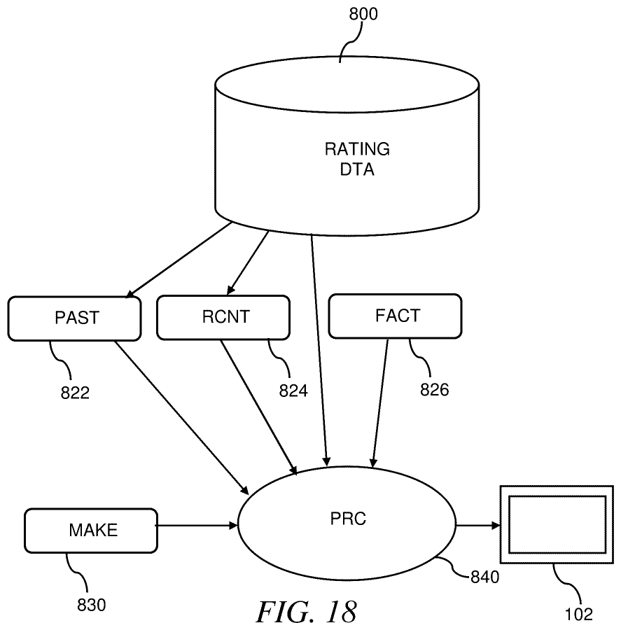

Referring to FIG. 18, an exemplary block diagram of the prediction feature of the rating system is shown. As sufficient rating data 800 is accumulated (e.g., months to years of rating data 800), it is anticipated that the rating data 800 will be used for auxiliary purposes such as making predictions that a manager/proprietor will use to drive purchasing, inventory, and staffing, etc. For example, if a certain week of the year has shown that a certain number of people order salmon, then history may repeat itself and an establishment might see similar orders, but other factors are in play. For example, if this is the first week of April, more people may go out to eat when it is sunny and 80 degrees and less may go out when it is rainy and cold. Further, when it is rainy and cold, people will often opt for comfort food like meatloaf. Therefore, the rating system provides predictions by a prediction process 840 that uses data from the rating data 800, in particular past data 822 (e.g., data for the past two or three years), recent data 824 (e.g., data from the last week or month), and external factors 826 (e.g., timing of holidays, weather predictions 826A, the economy 826B, currency exchange rates 826C, inflation rates 826D, etc.). For example, an establishment that sees a certain amount of traffic during the winter months, part due to visitors from Canada, will see different amounts of traffic when the exchange rate is worse for the Canadian traveler. All of this data feeds the prediction process 840 that uses an artificial intelligence mechanism to generate predictions (e.g., see FIG. 16) of what the establishment will need for the next period of time (e.g., for the week). In some embodiments, the prediction process 840 also receives as inputs the ratings 810/811/812/813/814/815, available seating 816, staff availability 817, manager availability, etc., to predict what will be needed and what demand can be met.

Further, in some embodiments, the prediction process 840 further accepts instructions for making 830 whatever is offered by the establishment (e.g., dishes, goods, services, etc.) and the prediction process 840, again using artificial intelligence, predicts what is needed to provide whatever the establishment offers. For example, if the establishment is a restaurant, then the prediction process 840 generates a prediction of what quantities of each meal will be required and, using the instructions for making 830 the item, the ingredients that will be needed to make those meals. Further, in some embodiments, the prediction process 840 predicts staffing levels that will be required and knowing information about the facility, caps of needs based upon capacity, etc. As another example, a florist will use the predicting portion of the rating system to know how many roses to order the week leading up to Valentines Day or Mother's Day and, based upon the external factors 826, the florist will know how many delivery drivers will be needed, etc.

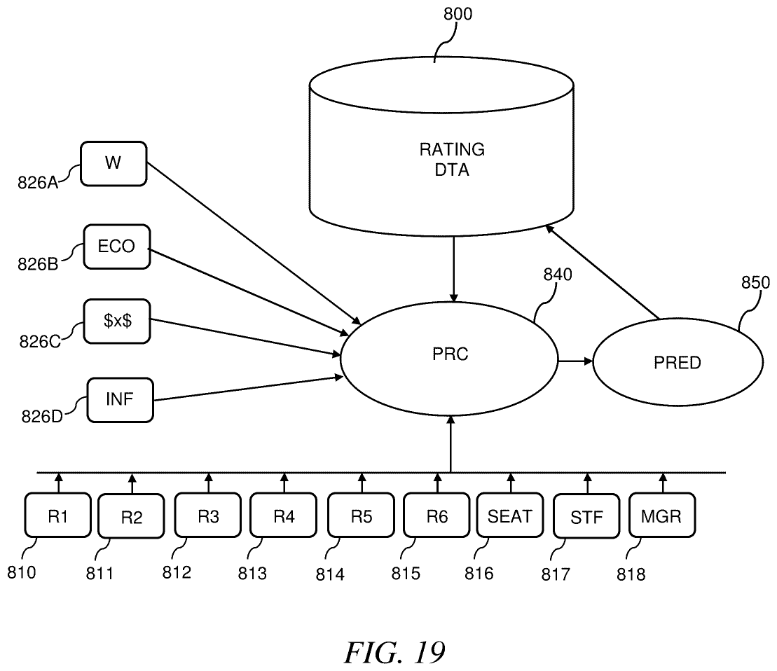

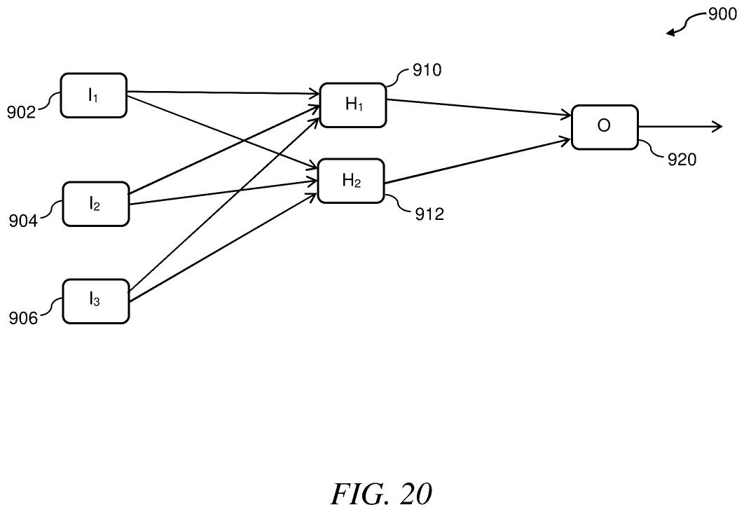

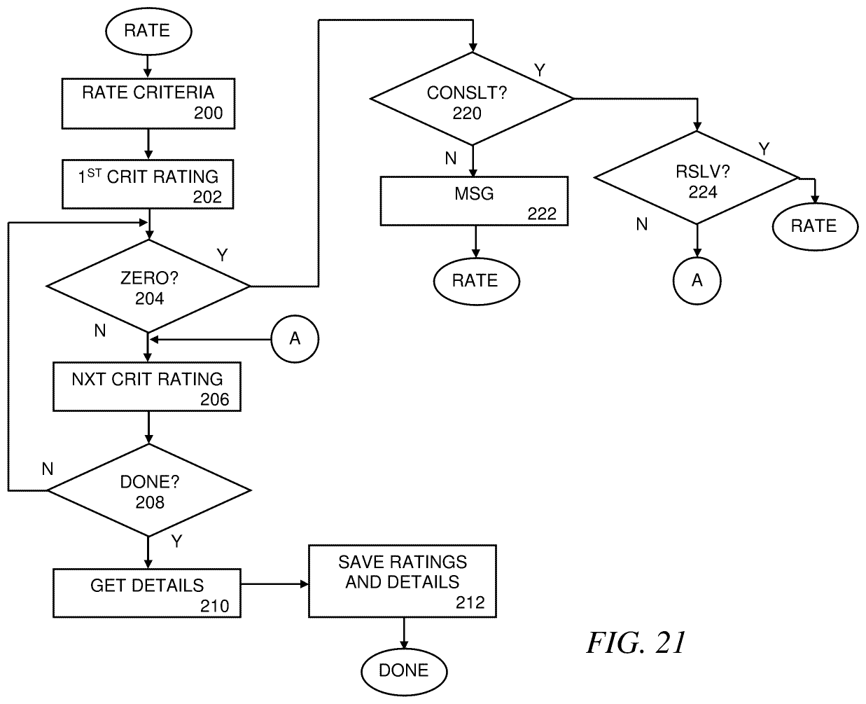

Referring to FIGS. 19 and 20, an exemplary implementation of the prediction process 840 within which a mathematical process represented by a simplified multilayer feed forward neural network is depicted. The prediction process 840 weighs rating data 800 with external factors 826. For example, for an eating establishment, outside factors such as weather predictions 826A, the economy 826B, currency exchange rates 826C, and inflation rates 826D are considered by the prediction process 840. In generating certain predictions, instructions for making various items 810/811/812/813/814/815 along with available seating 816, staff availability 817, and manager availability 818 are processed by the neural network of the prediction process 840 to, in effect, make predictions 850 of what will be needed in the future. In FIG. 21, a network 900 is shown with input values that are fed into neurons 902/904/906 with adjustments being made to weights and biases of hidden neurons 910/912 based on deviations between the output value of the output neuron 920 and desired sample output. The prediction process 840 constantly adjusts outputs based upon rating data 800 with external factors 826. The prediction process 840 further hones the artificial intelligence mechanism based upon feedback regarding the prior predictions that are fed back into the rating data 800. For example, if the prediction process 840 indicated that 135 pizzas are expected in a certain week and, after the week passes, actually 155 pizzas were sold, the feedback will be fed into the neurons 902/904/906/910/912 to improve the overall prediction process 840 and, therefore, future predictions.

Referring to FIG. 21, an exemplary program flow during the receipt of a set of rating criteria. Although ratings are preferred to be provided at the time of the experience (e.g., at the time of the meal, purchase, flight, hotel stay), ratings are accepted at any time. In this exemplary program flow, the ratings for each criteria are entered 200 (e.g., a n-star rating for each criteria such as food, price, ambiance, service and location). The receipt of a set of rating criteria starts with a reviewer entering 200 the ratings for each criteria (e.g., a numerical value, slider, number of stars). Now a loop begins to determine if any of the ratings includes a zero. The first criteria is selected 202. If the rating for the current criteria is zero 204, the reviewer is asked if they consulted management 220. If the reviewer did not consult management 220, then a message 222 is emitted (e.g., you cannot provide a zero rating if you did not try to correct the problem with staff at the establishment) and the above is repeated allowing the reviewer to change their ratings for that criteria. If the reviewer did consult management 220, the reviewer is asked if the issue was resolved 224. If the issue was not resolved 224, then the zero review is accepted. If the criteria did not receive a zero rating, then the loop continues selecting the next rating criteria 206 and if not done 208, the above is repeated.

Once all the review's ratings are checked and approved, as in some embodiments, details 210 are provided by the reviewer, for example, what entree was ordered, wait times, drinks ordered . . . . Note that in some embodiments, where available, the establishment's order fulfillment system will automatically populate the details 210. In such, it is anticipated that in some embodiments, the reviewer has tools to change or annotate the details 210. Finally, the ratings and the details are saved 212 in the rating data 800.

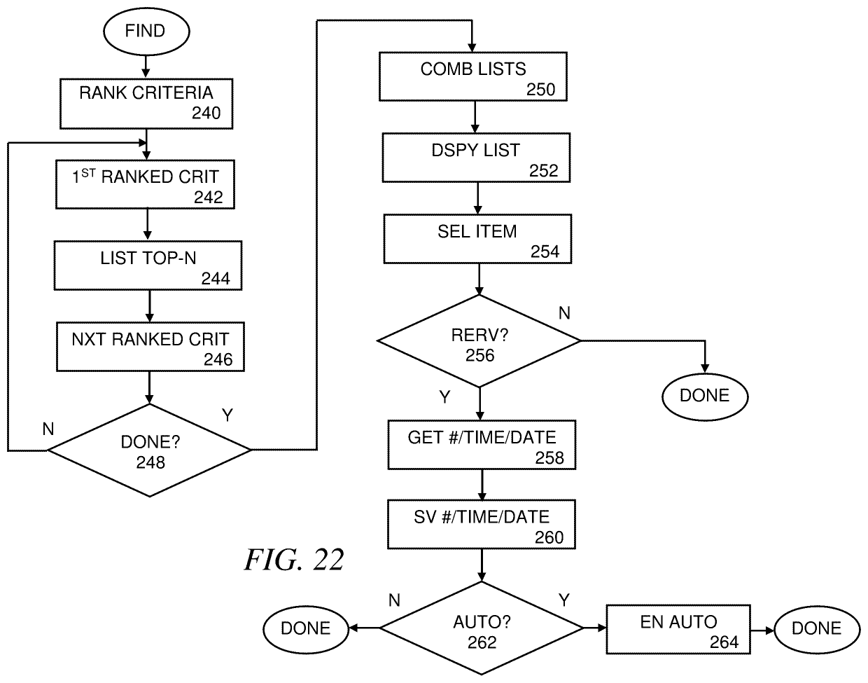

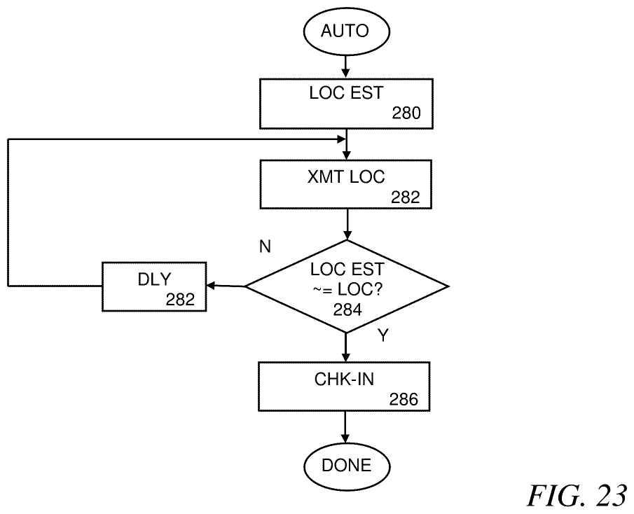

Referring to FIGS. 22 and 23, an exemplary program flow during search and automatic registration of the rating system is shown. As discussed, when using the search tools of the rating system and narrowing in on an item (e.g., an establishment, product, service), in some embodiments, the searcher is presented with an option to make a reservation, and in some further embodiments, has the ability to request automatic check-in upon coming within a certain distance of the establishment.

In FIG. 22, the searcher ranks the criteria 240, e.g., criteria for a specific type of establishment, service, product . . . . An example of this is shown in FIG. 8 for an establishment that provides food or dining. In this example, a loop starts selecting 242 the 1^{st} ranked criteria and generating a list is of the top-n 244 matches based upon that criterion. The next ranked criteria are selected 246 and the above repeats until there are no more criteria and the loop is done 248.

Now the lists are combined based upon the ranking of the criteria, and, therefore the ranking of the lists. For example, if the top ranked criteria was food, then establishments with a higher rating for food will be at the top of that list and if the next ranked criteria was price, then establishments with a higher rating for price will be at the top of the second list, and so forth. Now, the lists are combined 250 into a single list. In some embodiments, the lists are combined 250 using heuristics (e.g., weigh ratings of elements of the first list higher than the ratings of elements of the second list, then combining the two based upon the weighted ratings. In this way, an establishment that is very highly rated on price will appear above an establishment that is less rated on food. In some embodiments, the lists are combined using artificial intelligence in which a learning algorithm combines elements from each of the lists and receives feedback as to performance of the combining algorithm so that this learning algorithm learns each time it is used.

Once the final list is created, the list is displayed 252 and the searcher selects an item 254 from the list. For some list items, like restaurants, the searcher is allowed to make a reservation while in some, the searcher is allowed to make a purchase, book a hotel, arrange for a service like window cleaning, etc. If the searcher does not want to make a reservation 256 (e.g., reserve, purchase, request a service . . . ), the search is done.

If the searcher does want to make a reservation 256 (e.g., reserve, purchase, request a service . . . ), the ranking system obtains information about the reservation such as number of people, a date and time 258 for a restaurant reservation, but equally anticipated is color, quantity, class of service, location of service, etc. for other goods and services. The information (e.g., date/time) is saved 260 to complete the registration.

If the searcher does not want automatic registration 262, the search is complete and is done. Instead, if the searcher wants automatic registration 262, automatic registration is enabled 264 and the search is done.

Automatic registration as shown in FIG. 23 allows the registration system of the establishment to know when the searcher is within a specified distance of the establishment and, when the searcher is within that specified distance of the establishment, automatically check-in the searcher so that there is no waiting once the searcher (and their party) enter the establishment. The automatic registration starts with determining the location of the establishment 280 (e.g., location of main entrance or lobby), either by an electronic locating device such as GPS or by manually entering the location, for example, by entering coordinates or a pin on a map. Now a loop begins, running on a device that is with the searcher (e.g., a smartphone 100) in which the device transmits 282 its current location to the reservation system of the establishment. The location of the establishment is compared to the current location of the device If the location of the establishment is not within 284 the specified distance to the current location of the device, a delay is taken 282 (e.g., a 5 second delay to update every 5 seconds) and the above repeats, until the location of the establishment is within 284 the specified distance to the current location of the device, at which time the check-in process 286 of the establishment begins—for example, assigning a table, getting the required number of menus ready, pouring water, etc.

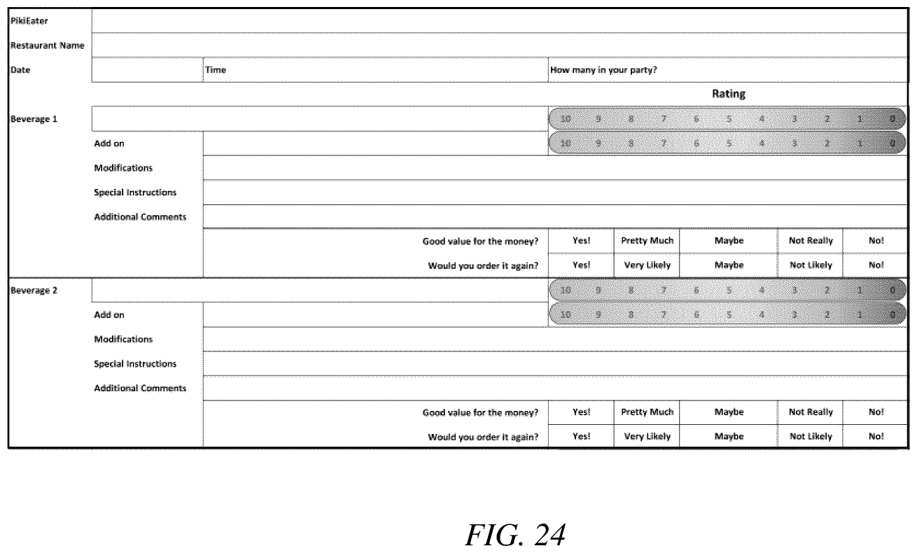

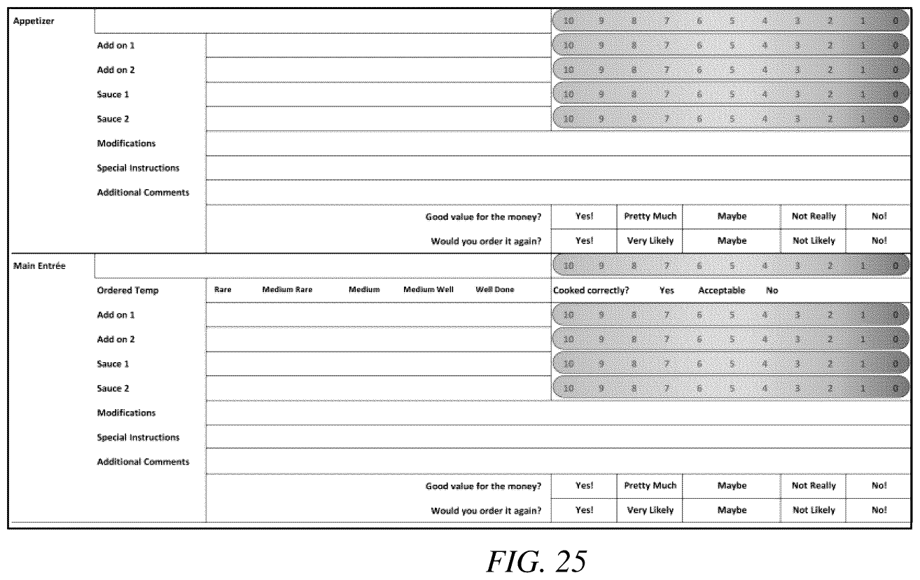

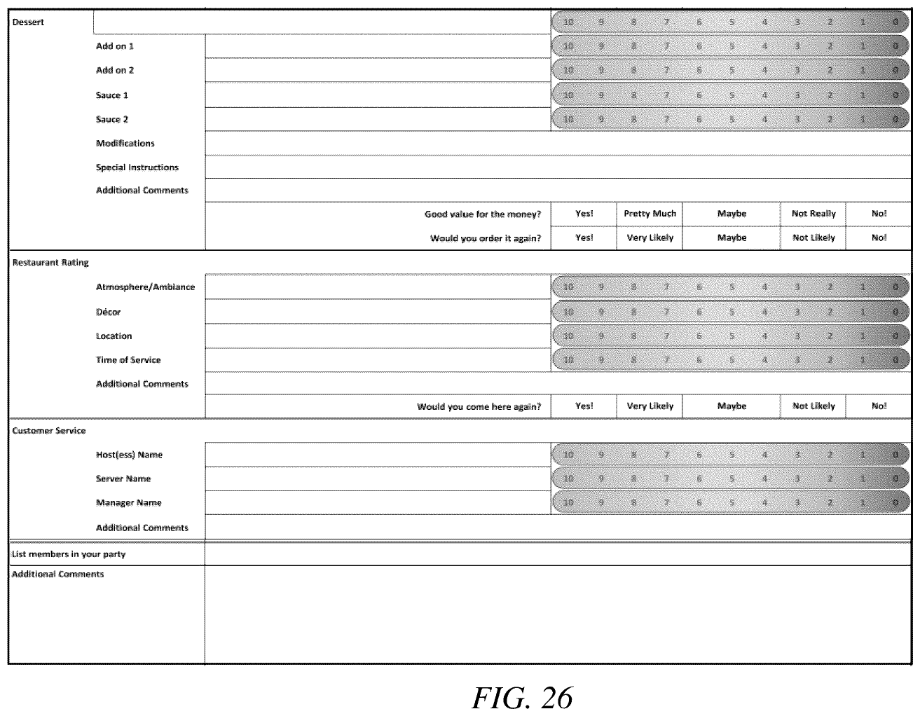

Referring to FIGS. 24-26, a sample rating input form or user interface of the rating system. This sample rating input form is shown across three figures (FIG. 24, FIG. 25, and FIG. 26) to provide a sample of what one might rate at a restaurant. Note that for some items, there are duplicates (e.g., Beverage 1, Beverage 2) as one might order more than one item and each may have a different rating. For example, when the user orders two frozen daquiris and the first one is great, and the second one is not very frozen . . . . Further, different categories are anticipated for different regions. For example, in Italy, it is customary to have choices of an appetizer, first plate (e.g., pasta), second plate (e.g., meat), side dish (e.g., a vegetable), then a salad, then desert. Also note that in this example, the ratings allow for zero to ten.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A method for rating products or services, the method comprising:
creating an account for a user;
after receiving a product or a service from an establishment, providing a description of the product or the service and ratings for categories related to the product or the service; and
storing a name of the establishment, the description of the product or the service, a date of receiving the product or the service, and the ratings in a database.

2. The method of claim 1, wherein the product or the service is food from the establishment.

3. The method of claim 2, wherein the categories related to the food comprise a rating for the food, for a service provided by the establishment, for a price, and for an ambiance provided by the establishment.

4. The method of claim 3, wherein the name and location of the establishment is stored in the database.

5. The method of claim 4, wherein an overall rating for each of the categories is calculated by averaging the ratings from a plurality of users.

6. The method of claim 4, wherein an overall rating for at least one of the categories is calculated by averaging the ratings from a plurality of users using a priority based upon the date of receiving the product or the service.

7. The method of claim 1, further comprising:
for a given establishment, retrieving the description of the product or the service for the user, thereby providing an indication of what was purchased by the user at the establishment.

8. The method of claim 6, further comprising:
searching the database by providing a prioritized list of importance of the categories, returning a list including the name of the establishment prioritized by the overall rating of the prioritized list of importance of the categories.

9. A method for rating restaurants, the method comprising:
creating an account for a user;
after receiving a meal from a restaurant, providing a description of the meal and ratings for categories related to the meal using the account; and
storing a name of the restaurant, a location of the restaurant, the description of the meal, a date of receiving the meal, and the ratings in a database.

10. The method of claim 9, wherein the categories related to the meal comprise a rating for: the meal, for a service provided by the restaurant, for a price of the meal, and for an ambiance provided by the restaurant.

11. The method of claim 9, wherein an overall rating for at least one of the categories is calculated by:
for at least one of the categories, creating the overall rating of the at least one of the categories by averaging the ratings from a plurality of users using a priority based upon the date of receiving of the meal; and
for at least one of the categories, creating the overall rating of the at least one of the categories by averaging the ratings from the plurality of users.

12. The method of claim 11, further comprising:
searching the database by providing a prioritized list of importance of the categories, returning a list of restaurants prioritized by the overall rating of the prioritized list of importance of the categories.

13. The method of claim 11, wherein the ratings for each of the categories related to the meal include a zero rating and the zero rating is allowed only after the user acknowledges escalating a problem to waitstaff or a manager and only after no acceptable resolution was offered.

14. A system for rating products and services, the system comprising:
a user device having a processor, an input device interfaced to the processor, a network interface interfaced to the processor and communicatively coupled to a network, a display interfaced to the processor, and a memory interfaced to the processor;
a server computer having a server processor, a server memory interfaced to the server processor, a server network interface operatively interfaced to the processor and communicatively coupled to the network, and a persistent storage operatively coupled to the server computer and accessible by the server processor;
a ratings database is stored in the persistent storage;
the processor is configured to receive rating data from the input device and to send the rating data to the server computer;
the server processor configured to receive the rating data from the user device and to store the rating data in the ratings database along with a timestamp; and
whereas the rating data comprises a name of an establishment, an identity of the products or the services and at least two categories of the rating data selected from a group consisting of quality, service, price, and ambiance.

15. The system of claim 14, wherein the establishment is a restaurant, the products or the services is a food item, the quality is the quality of the food item, the service relates to waitstaff, the price is an overall price of the food item, and the ambiance is an atmosphere of the restaurant.

16. The system of claim 14, wherein the user device is a smartphone and the input device is selected from a group consisting of a touch screen and a microphone.

17. The system of claim 14, wherein, for each establishment, software running on the server processor calculates an overall rating for each product or each service by averaging one or more individual ratings for that product or that service.

18. The system of claim 14, wherein, for each of the at least two categories there is a weight based upon an age of each individual rating and for each establishment, software running on the server processor calculates an overall rating for each product or each service by averaging one or more individual ratings for that product or that service prioritized by the weight of the one or more individual rating.

19. The system of claim 14, further comprising:
software running on the processor of the user device presents a searching user interface on the display and the software receives an order of the at least two categories from most important to least important from the input device and then the software causes the user device to transmit the order of the at least two categories to the server computer;
upon receipt of the order of the at least two categories, software running on the server computer selects one or more establishments based upon overall rating of the at least two categories based upon the order of the at least two categories;
the software running on the server computer transmits the names of the one or more establishments to the user device; and
upon receiving the names of the one or more establishments at the user device, the software running on the user device displays the names of the one or more establishments on the display.
